(19) United States
(12) Patent Application Publication
(10) Pub. No.: US 2002/0152009 A1
(43) Pub. Date: Oct. 17, 2002

(54) Method and apparatus for determining operational air quality and predicting vehicle performance

(76) Inventor: Fred J. Bartoli, Schiller Park, IL (US)

Correspondence Address: DEBRA J. FICKLER, 12525 GRANDVIEW DRIVE, HUNTLEY, IL, 60142, US

(21) Appl. No.: 10/122,255

(22) Filed: Apr. 11, 2002

Related U.S. Application Data
(60) Provisional application No. 60/283,249, filed on Apr. 11, 2001.

(51) Int. Cl. G06F 19/00

(52) U.S. Cl. 701/29; 340/439

(57) ABSTRACT

This invention described an air quality measuring device and vehicle performance predictor whereby normalized air quality conditions and vehicle performance factors are calculated based upon atmospheric and vehicle operational data inputs. The controller of air quality measuring device and vehicle performance predictor is connected to temperature, pressure, humidity, oxygen and light sensors. The sensor measure the ambient atmosphere and inputs the collected data into the controller. The controller calculates normalized air quality conditions such the oxygen content and moisture concentrations in the atmosphere. All stored and calculated normalized air quality conditions and vehicle performance factors are displayed on a visible screen on the controller, stored in memory of the controller and may be sent to a remote transceiver, printer or computer.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates to an apparatus that collects air quality conditions and calculates an atmospheric performance factor that relates the performance of an internal combustion engine to a particular atmospheric condition at a particular moment in time. The atmospheric performance formula predicts vehicle performance for the collected conditions with out the use of a personal computer. Specifically, the controller of the present invention provides an interface that displays collected air quality conditions, atmospheric performance factor, and stored vehicle operational data previously inputted and stored in the controller. The controller also provides an optional remote receiver with a display to allow the user to read the stored and calculated information at a remote location.

### BACKGROUND OF THE INVENTION

Internal combustion engines utilize air and fuel such as gasoline, diesel fuel, alcohol, or alcohol-gasoline. This combination of fuel and air, often referred to as the “charge”, enters the combustion chamber and explodes as the piston compresses the charge and along with a spark created by a spark plug, except in traditional diesel engines in which the charge explodes as the diesel and air mixture is compressed. For optimum performance and consistent running of the engine, the combination of air and fuel must be controlled to create a charge that burns efficiently. Various devices have been developed to control the amount of air and fuel in the charge. Most vehicles including passenger cars and motorcycles, utilize either a carburetor or fuel injection. Various forms of fuel injection have been developed such as single fuel injector which sits above a throttle body that intakes air, combines it with fuel and delivers the mixture to the cylinders. Fuel injectors may also be placed in the intake manifold to inject the fuel as the air travels through the intake and directs the mixture to the engine cylinders. Lastly, direct injection consists of one or more injectors that inject fuel directly into the combustion chamber or cylinder. These fuel injection systems typically utilize a computer, often referred to as the “ECU” (electronic control unit), along with sensors to measure the current operating conditions of the engine such as a manifold absolute pressure sensor, or “MAP” for short, to measure the pressure of air flowing through the intake manifold. The computer may also receive other operational conditions such as engine revolutions per minute, “R.P.M.”, or charge temperature. The ECU receives the engine operating conditions and utilizes either algorithms or a look-up table to determine the optimal amount of fuel to inject for the air inspired to increase efficiency of the engine, referred to as stoichiometric ratio (14.7:1 for gasoline engines).

In performance applications such as racing, the driver or crew chief may attempt to control the delivery of fuel and air to the combustion chamber to find the optimum combination for a particular engine and racing application. All engines, including naturally aspirated engines and forced air engines, those that super or turbocharged, draw air from the atmosphere. Thus, the racer or crew chief must consider the current environmental conditions the vehicle will be operating in to formulate the proper engine set-up. Any change in temperature, barometric pressure, humidity or combination thereof will affect the performance characteristics of the engine due to the content of oxygen in the air. For example, on a day of low humidity, a standard volume of air will contain a certain percentage of oxygen, water vapor and other gas molecules. As the humidity increases, the amount of water vapor molecules increase and displace the molecules of oxygen and other gases. Therefore, the standard volume of air will contain less oxygen and more water vapor.

To compensate for the changing amount of oxygen available in the air, the racer or crew chief may increase the amount of fuel that is delivered to the combustion chamber. This may be done by changing the sizes of jets in a carburetor or increasing the amount of time a fuel injector is open which, in turn, increases the amount of fuel injected into the combustion chamber.

Temperature also may affect the amount of oxygen in the air. At high temperatures, the spaces between the oxygen, water vapor, and gas molecules in the same standard volume of air will be greater than the same volume of air on a cooler day. These temperature changes will typically affect the performance of an engine. Engines that are computer-controlled will often use a MAP sensor to monitor changes in the intake air and adjust the fuel accordingly. However, carbureted engines typically do not measure MAP and some fuel injection systems may not compensate for changes in MAP. Turbocharged and supercharged engines are less affected by changes in temperature due to the fact that both chargers compress the air or air-exhaust mixture to increase the density of the charge (minimizes the gaps between the molecules thereby increasing the amount of oxygen molecules in the charge) entering the combustion chamber.

The engines used in motorized racing applications such as drag racing, circle-track, road course racing and even motorized, 2-cycle kart racing are affected by the current and changing atmospheric conditions. Furthermore, most racing vehicles are also affected by wind. It is well known in the art of racing that wind can either slow down or increase the speed of the car. Racecar chassis builders attempt to create the most aerodynamically efficient body that creates maximum down-force. Various spoilers, wings and faring are often added to the body of the car to minimize drag and increase down-force. However, these spoilers and wings may hinder car maneuverability and stability. Thus, the crew chief or mechanic often uses average wind and gust speeds along with the direction of the wind to determine the physical set-up of the car such as wing angle. In drag racing application it is common for the racer to adjust the elapsed time the car may run in a quarter or eight-mile due to the drag of the wind or push of a tail wind. Therefore, there is a need to provide a system, which is capable of collecting and calculating accurate and repeatable atmospheric and weather conditions.

Hand-held weather stations have been developed that measure atmospheric conditions. However, the accuracy of these systems depends upon the position of the sensors, such as whether the unit is placed in the sunlight, shade or wind. Furthermore, for the most accurate weather information, the unit should be kept in one place. Due to the portability of these hand-held units, there is a tendency for the driver or crew chief to take the unit to the starting line to determine the weather conditions before making last minute changes on the car. Albeit convenient, the hand-held unit has lost its reference when moved. For example, if the unit was placed in the shade at the racer's pit spot, any reading taken in the direct sun light at the starting line may be inaccurate. This may cause the racer to under or over compensate for a changing weather condition, which will affect the ultimate performance of the engine. This is especially important to drag racers where a race may be won or lost by a thousandth of a second.

Sportsman racers often utilize these smaller hand-held weather stations or standard humidity, barometric and temperature gauges and a calculator to calculated correct air density, which references the air to sea level. For repeatability, the gauges must be placed in a reference position at each race. However, this may be impractical due the pit area and the gauges must be calibrated to ensure accurate readings. These calculations can also be performed on a personal or laptop computer. However, most sportsman racers do not have the extra funds to buy a computer for the race trailer.

Professional race teams often utilize data collections systems that monitor engine functions and other conditions such as shock travel on the racecar during the race. Likewise, they often record weather conditions in an “electronic” logbook that contains race or lap information. Sportsman teams without room for a computer or fund for one to carry in the race trailer may input these weather and race data in a database on a computer after the event at home. Laptops are ideal for these applications because they can be used at the home and then on the road with the racer for the weekend. However, during the rush of packing, the racer may forget to take the laptop and place it in the race trailer or tow vehicle. Furthermore, to utilize the computer to record weather information requires a power supply. Although most laptops batteries can hold a charge for a few hours, some racing events are three to four days for qualifying and racing. Thus, the racer must have the electrical power available to keep the batteries charged.

Drag racing applications often require the racer to “dial” the car. That is, the racer must estimate the elapsed time the car will run in a quarter mile and write that information on the window of the car. The racetrack uses this “dialed” number to determine when to start the starting line lights. For example, if a car that dialed 10.00 seconds races a car that is dialed 9.50seconds, the starting line light will turn on for the slower car 0.5 seconds before the faster car's light. In a class of drag racing commonly called “super class racing” the racer must “set-up” the car to run a particular elapsed time in a quarter-mile such as 8.90 seconds, 9.90 seconds or 10.90 second. These drag racers will utilize past run and weather data to either predict what the car will run. In the super class races, the racer may use a timer called a throttle stop which acts to restrict the fuel and air to the engine or will control the throttle position, to slow the car down for a particular amount of time to make the car run the 9.90, 9.90 or 10.90 seconds. Sportsman racers typically record all runs and weather information in a paper logbook for reference at later races to predict how the car will run.

Therefore, there is a need in the racing community for a weather station that provides accurate and repeatable weather data. Likewise, there is a need for a system that is capable of collecting and displaying atmospheric air quality conditions, predicting the performance of the vehicle under the current atmospheric air quality conditions, and store past race information such as elapsed time, speed, electronic timer values, shock set and other conditions. Furthermore, there is a need for a system that can provide the racer accurate race information at the starting and one that can predict vehicle performance factors such as throttle-stop timing and transmit that information to the racer at any time.

### BRIEF SUMMARY OF THE INVENTION

The present invention provides a unique approach to collecting accurate weather information and display the atmospheric conditions to a racer as well as calculating the atmospheric performance factor which related the performance of an internal combustion engine to a particular set of atmospheric conditions. Moreover, the present invention determines vehicle performance factors such as throttle-stop timing or predicted elapsed time without the use of a laptop or personal computer.

In racing applications such as drag racing, races are often won or lost, by ten thousandths of a second. Therefore, the racer must be able to tune the racecar for particular atmospheric conditions at the time of the run. Also, the racer must do so in a race where the atmospheric conditions may change over the one to four days of a race. One method of recording this information is to write vehicle performance and weather conditions in a logbook. The racer can then compare weather conditions from race to race and use the information to predict how a racecar will run under those or similar conditions. Often the racer will attempt to find a relationship between to a particular weather condition and its effect on elapsed time. To determine this mathematical relationship, the racer must have a larger number of runs or lapse in various weather conditions. Moreover, the racer must compensate for the altitude of the track and its affect on the weather and the engine.

To simplify the process of determining the mathematical relationship, racer often calculate a normalized weather reading to sea level, which compensates for the altitude of the track. With the elapsed time information and normalized air conditions (also referred to as “sea-level air”, “density altitude” or “corrected density altitude”), the racer can plot the information on a graph of normalized air versus elapsed time. Using a statistical regression analysis, the racer can predict the performance of the racecar at a particular normalized air value. This corrected density altitude uses weather information such as barometric pressure, temperature and humidity. However, this method may provide inaccurate results due to the fact that weather information must be consistently and accurately collected and the calculated formulas or graphs must be followed. Often, gauges may be hard to read or out of calibration, or the graph used may not display the effects of a small change in air conditions. Another disadvantages of this method are that a person must read the gauges and determine the readings, plotting and calculations. Also, one crew member may place the gauges in the sunlight or wind for a race and then at the next race place the gauges is the shade, where it is shielded by the wind.

The present invention provides a method and stand-alone system for calculating the atmospheric performance factor for a vehicle at a particular time. Furthermore, the present invention allows the user to input run and past weather data into the controller for later review without the need for a laptop or personal computer. The controller utilizes the past run and collected air quality conditions, and an atmospheric performance formula to determine and predict the atmospheric performance factor and vehicle operational performance factors such as elapsed time and throttle-stop setting.

Moreover, the present invention provides a method for collecting accurate and repeatable atmospheric weather information. The system provides remote mounted air-collecting sensors that are always placed in the same reference location when used such as on top of a racecar trailer, transporter or tow vehicle. Theses sensors collect atmospheric weather information and send the data to a controller. Multiple wind sensors may also be utilized which are positioned to be in the same direction as the run of the racetrack to determine head, cross and tail wind conditions. The direction and velocity reading are also recorded for each run of the racecar and the controller may be used to calculate the loss or gain of elapsed time for the current wind conditions.

The controller also contains a user interface to interact with the user. The user can input past run data into the controller using a keypad, mouse or similar input device. A display is provided on the controller to display current air quality conditions and corresponding calculated atmospheric performance vehicle performance factors. The controller may be used to collect, display and store air quality conditions, calculated performance factor and vehicle performance factors with out the need for a computer or laptop. The controller is powered by any 12 Volt power source such as a trailer battery or small motorcycle battery. The controller may also utilize a transmitter to transmit the calculated collected air quality conditions and calculated atmospheric performance and vehicle performance factors to a remote receiver. This allows the racer to leave the air-collecting sensors at a single location at every racer and receive the data via a remote receive such a display screen on a pager.

The controller utilizes a non-volatile memory to store the user inputted run data. Thus, once the air-collecting sensors are removed from the controller, run data, air quality conditions and the calculated atmospheric performance factor, and vehicle performance factors are stored in the non-volatile memory in the controller. These values may be displayed at a later time using the controller. Alternatively, the user may download the information from the controller to printer, laptop or personal computer for plotting or later reference.

The details of the invention, together with further objects and advantages of the invention, are set forth in the detailed description which follows. The precise scope of the invention is defined by the claims annexed to and forming a part of this specification.

### BRIEF DESCRIPTION OF THE DRAWINGS

A better understanding of the present invention is obtained when the following detailed description is considered in conjunction with the following drawings as described below:

FIG. 1 is a perspective view of a controller, remote mounted air-collection sensors, and transmitter antenna and remote receiver with a display;

FIG. 2 is a diagrammatic view of the remote mounted air-collection sensors, and the back of the controller;

FIG. 3 is a block diagram of the controller according to the invention;

FIG. 4A and 4B is a circuit diagram of the controller;

FIG. 5 is a flow chart of the microprocessor operations of the controller;

FIG. 6 is a listing of the menus of the controller;

FIG. 7is a top plan view of the controller and displayed screens;

FIG. 8 is a top plan view of the remote receiver and associated displayed screen; and

FIG. 9 is a front plan view of a computer screen and screens when connected to the controller.

### DETAILED DESCRIPTION OF THE INVENTION

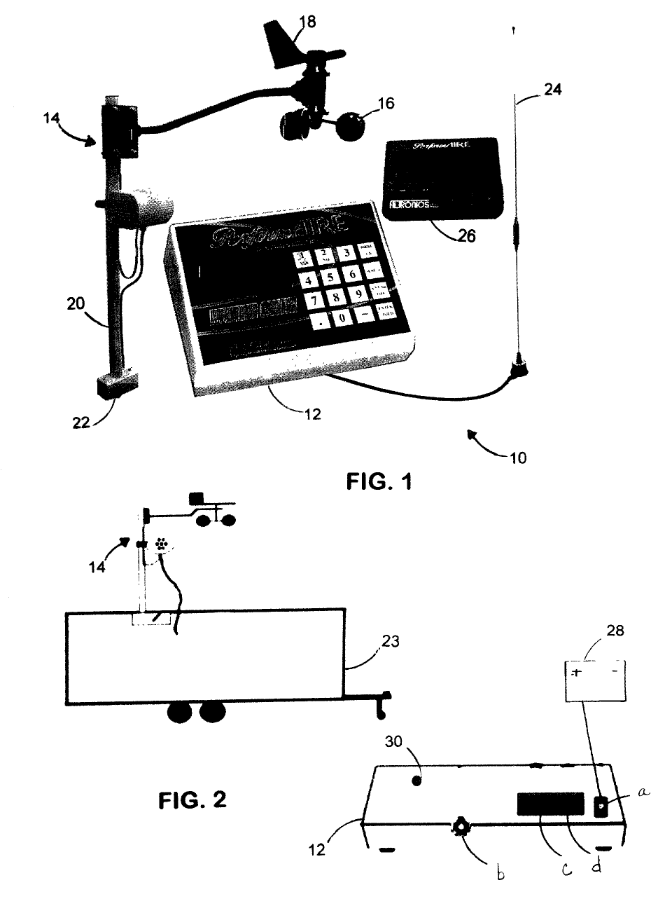

Referring to the drawings, FIG. 1 is an illustration of the weather and prediction system 10 for collecting air quality conditions, calculating atmospheric performance factor, and predicting vehicle performance. Weather center and prediction system 10 consisting of a controller 12, remote mounted air-collecting sensors 14 which contains a wind speed and gust sensor 16, wind directional sensor 18 mounted on a pole 20. Also positioned on pole 20 is an air-collecting housing 21, which contains the temperature, humidity and pressure sensors (not shown). To ensure that the remote mounted air-collecting sensors 14 are positioned at the same location at every race, a mounting bracket 22 is fixed to a racecar trailer or transporter 23. Controller 12 may also acts as a transmitter and sends a radio frequency signal via a remote mounted antenna 24 to a receiver 26 which displays the collected and calculated atmospheric performance factor at a remote location.

Controller 12 and remote mounted air collecting sensors 14 are powered by a power source 28 as shown in FIG. 2. In one embodiment a 12 Volt battery was used; alternatively, a 12 Volt, 1 amp AC transformer may be connected to controller 12 at a point “a” to supply power to controller 12 and remote mounted air-collecting sensors 14. Remote mounted antenna 24 is electrically coupled to controller 12 at a point “b” as shown in FIG. 2. Remote mounted air collecting sensors 14 are electrically connected to controller 12 at a point “c” and a connection to coupler controller 12 to a computer (not shown) is also provided at a point “d.” A circuit breaker 30 is also provided in controller 12 to prevent damage from power spikes.

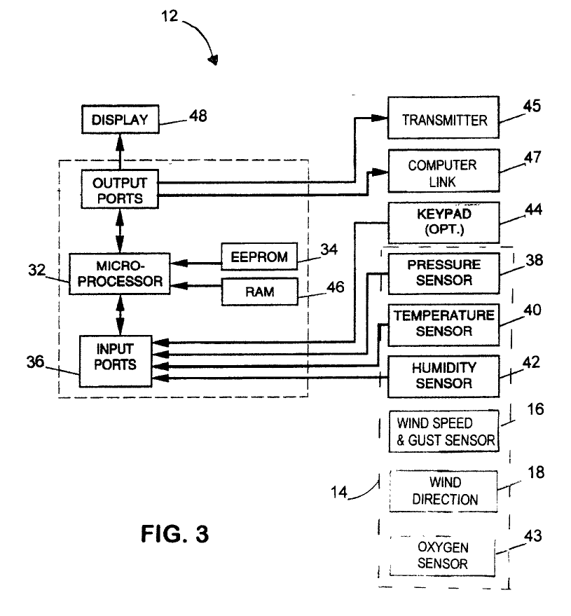

Referring to the schematic representation of controller 12 in FIG. 3, controller 12 utilizes a microprocessor 32 and EEPROM 34 to collect air quality conditions and calculate atmospheric performance factor and vehicle performance factors. Controller 12 receives inputs from remote mounted air collecting sensors 14 at input port 36. Remote mounted air collecting sensors 14 collectively comprise wind speed and gust sensor 16, wind direction sensor 18, a pressure sensor 38, temperature sensor 40, humidity sensor 42 and oxygen sensor 43. In one embodiment, a commercially available altimeter pressure sensor was used, a YSI 44004 Precision Thermistor made by YSI Incorporated of Yellow Springs, Ohio, a MiniCap 2 Relative Humidity Sensor from Panametrics, and commercially available speed and director sensor were used. Controller 12 also receives user inputs at input port 34 via a keypad 44 located on the counsel of controller 12.

Controller 12 also receives user inputted vehicle operational data via keypad 44 and stores such information in RAM memory 46. As the user inputs such data using keypad 44, the information is also displayed on an LCD display 48. Stored run information such as elapsed time values, engine parameters, air quality conditions and calculated atmospheric performance factor can be recalled from memory 46 and read from display 48. A computer (not shown) may be connected to controller 12 via computer link 47 and stored information may be transferred from memory 46 to the computer. However, a computer is not needed to operate weather center and prediction system 10. Controller 12 also contains a radio frequency transmitter 45 for sending the air quality conditions and calculated atmospheric performance factor and vehicle performance factors at a distance of 1to 2 miles from controller 12 sent via remote mounted antenna 24 to receiver 26.

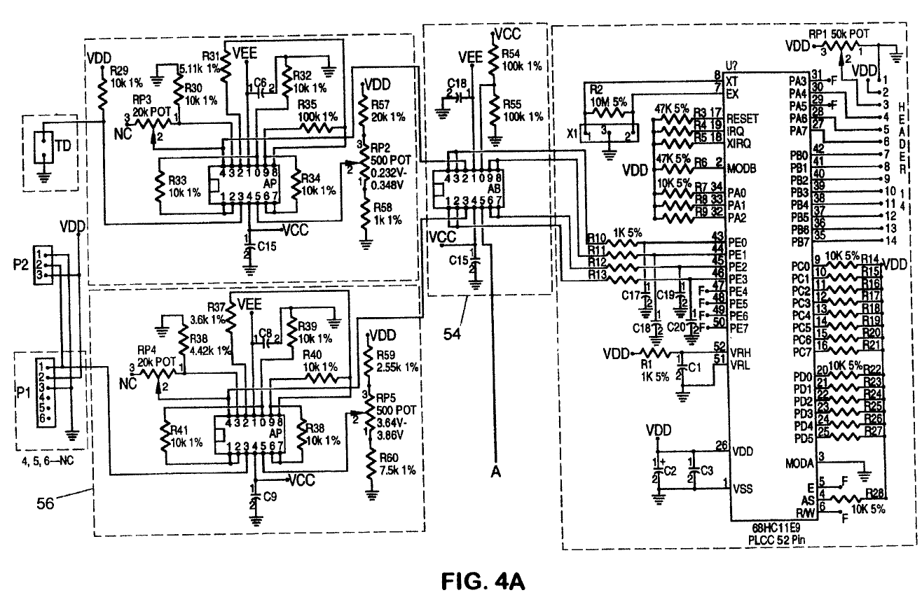

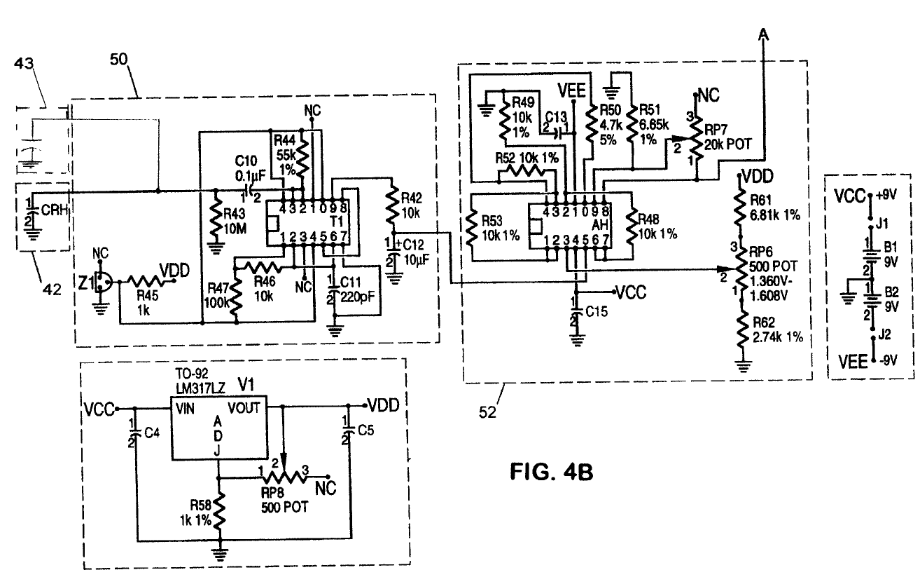

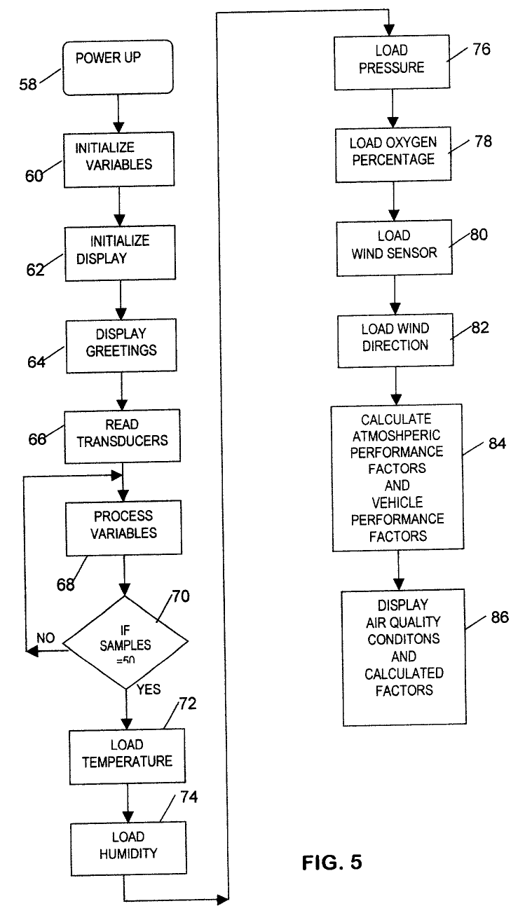

A schematic representation of weather center and prediction system 10 is shown in FIG. 5. Microprocessor 32 requires digital inputs such that the output of analog sensor must be converted to a voltage signal. As shown in FIGS. 4A and 4B, humidity sensor 42 requires a pulse width generator and voltage reference to drive humidity sensor 42. Humidity pulse width generator and voltage reference 50 sends the humidity sensor 42 input to a humidity signal conditioner 52, which, in turns, sends the analog voltage to an analog/digital converter 54. Pressure sensor 38 sends its input to a pressure sensor conditioner 56 and then to analog/digital converter 54. Microprocessor 32 accepts digital inputs from analog/digital converter 54 and processes air quality conditions and calculate atmospheric performance and vehicle performance factors, which are shown on display 48. Further, keypad 44 may also be used to input air quality conditions or vehicle information for later use in memory 46. Microprocessor 32 uses an atmospheric performance formula to calculate the atmospheric performance factor that the user references to predict how the racecar will perform und those weather conditions. Microprocessor 32 also performance a statistical regression analysis to predict vehicle performance factors based upon collected, real-time data readings such as predicted elapsed time and throttle-stop timer settings.

Turning to operational flow chart in FIG. 5, once controller 12 is powered 58, microprocessor 32 initializes air quality conditions 60 which are needed to calculate the atmospheric performance factor and initializes display 48 at step 62. The system greetings and other information such as time and date and menu choices are then shown on display 48 at step 64. Microprocessor 32 reads the sensor information from remote mounted air collecting sensors 14 at step 66 and converts the readings into digital form at step 68. Microprocessor 32 then determines whether there are enough samples to calculate an average value of each of the inputs. If the samples are less than fifty (step 70), then remote mounted air-collecting sensors 14 are read again. This operation of multiple polling of sensors is to minimize the effect of an aberrant reading from any of the remote mounted air collecting sensors 14.

If sufficient samples were taken, the quality conditions including air temperature 72, humidity 74, atmospheric pressure 76, oxygen percentage 78 (if the sensor is present), wind speed 80 and wind direction 82, are loaded by microprocessor 32. Microprocessor 32 then calculates the atmospheric performance factor utilizing the absolute pressure, oxygen percentage, wind speed, wind gust speed, wind direction, dew point, vapor pressure, and oxygen percentage. Microprocessor 32 also predicts vehicle performance factors based upon the calculated atmospheric performance factor at step 84. Lastly, the air quality conditions, atmospheric performance factor and vehicle performance factors in the form of elapsed time or timer length in seconds are displayed at step 86.

Microprocessor 32 calculates the atmospheric performance factor on scientific, proprietary equations. The atmospheric performance formula is derived from the ideal gas laws using temperature, relative humidity and barometric pressure of the atmosphere at a given moment in time. For a complete example of using air quality conditions to determine “density altitude”, see U.S. Pat. Ser. No. 5,509,295, entitled WEATHER STATION DEVICE, assigned to applicant, which is hereby incorporated by reference as is necessary for a full and complete understanding of the present invention.

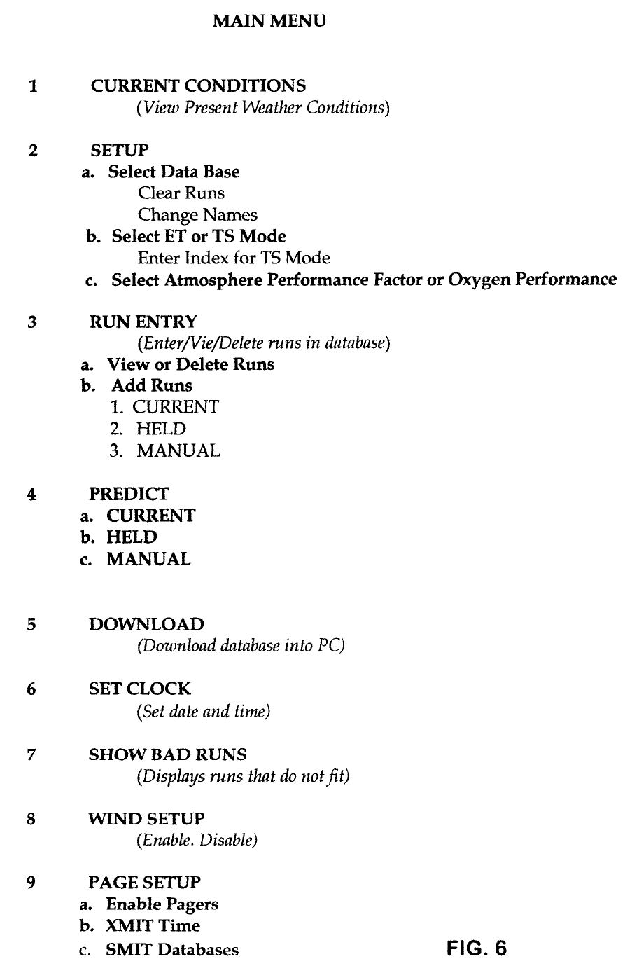

Once controller 12 is connected to battery 28 and remote mounted air collecting sensors 14, a main menu is shown on display 48. From this menu, the user may customize controller 12 to his or her needs via keypad 44. Each menu selection is identified with a numerical value as shown in FIG. 6. Multiple vehicle information may be stored in memory 46 and controller 12 is capable of displaying simultaneously vehicle performance factors for more than one vehicle.

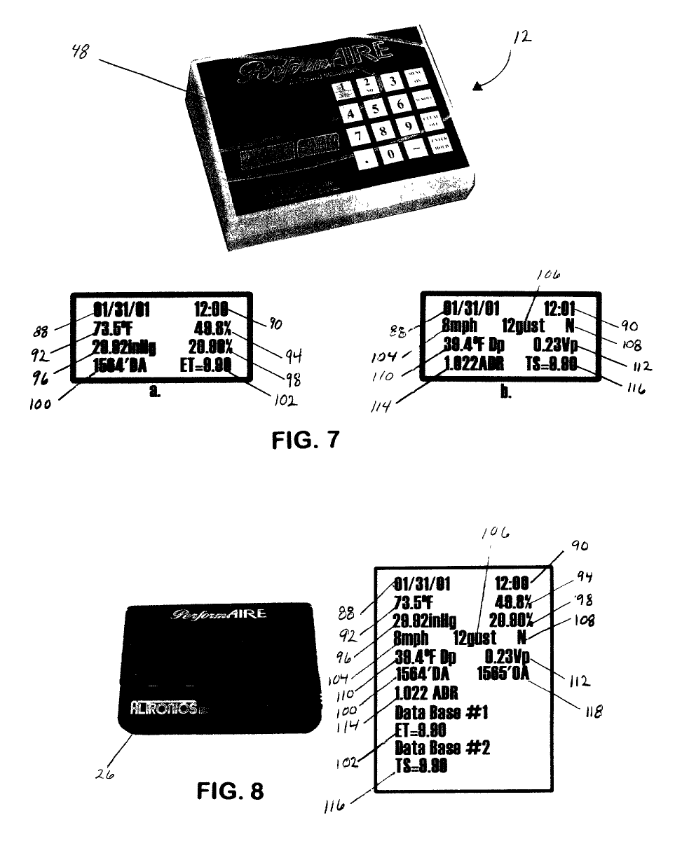

Turning to FIG. 7, controller 12 is shown with display 48. To keep the size of controller 12 to a minimum, a four-line LCD display was used. To display the normalized air quality conditions, the text scrolls such that all information is displayed in 2 screens. As shown in screen “a”, the current date 88 and time 90 is displayed and for that time, temperature 92, humidity 94, absolute pressure 96, percent oxygen 98, calculated atmospheric performance factor 100 and vehicle performance factor-elapsed time 102 for those current air quality conditions. After displaying screen “a”, controller 12 then scrolls display 48 to list the information shown on screen “b.” Again, current time 88, date 90 is displayed along with the average wind speed 104, maximum wind gust speed 106, and wind direction 108. Also shown on screen “b” is the dew point temperature 110, vapor pressure 112, altitude density ratio 114 and vehicle performance factor, timer-setting 116. Alternatively, oxygen atmospheric performance factor 118 (see FIG. 8) may be displayed by controller 12 in place of the calculated atmospheric performance factor 100.

The air quality conditions and calculated atmospheric performance vehicle performance factors may also be displayed on remote receiver 26 as shown in FIG. 8. In one embodiment a Motorola pager was used. Due to the limited size of receiver display 48, the air quality conditions and calculated atmospheric performance and vehicle performance factors are also displayed on a scrolling screen. The same information as displayed on controller 12 is sent via transmitter 45 to receiver 26 and is shown in FIG. 8b.

As stated above, controller 12 may be connected to a computer (not shown) to recall stored data in memory 46 and store additional data regarding a run of the vehicle. Likewise, a computer may also be used to store the collected air quality conditions in real-time as controller 12 computers the values. Turning to FIG. 10, the user may input via a computer, vehicle run information 120 as shown in screen “a”. The user may input the air quality conditions and calculated atmospheric performance and vehicle performance factors for that run. This information is then stored in the memory of the computer for recall at a later date. The user may search the vehicle run information for similar air quality conditions, calculated atmospheric performance factor, run information, or racetrack location.

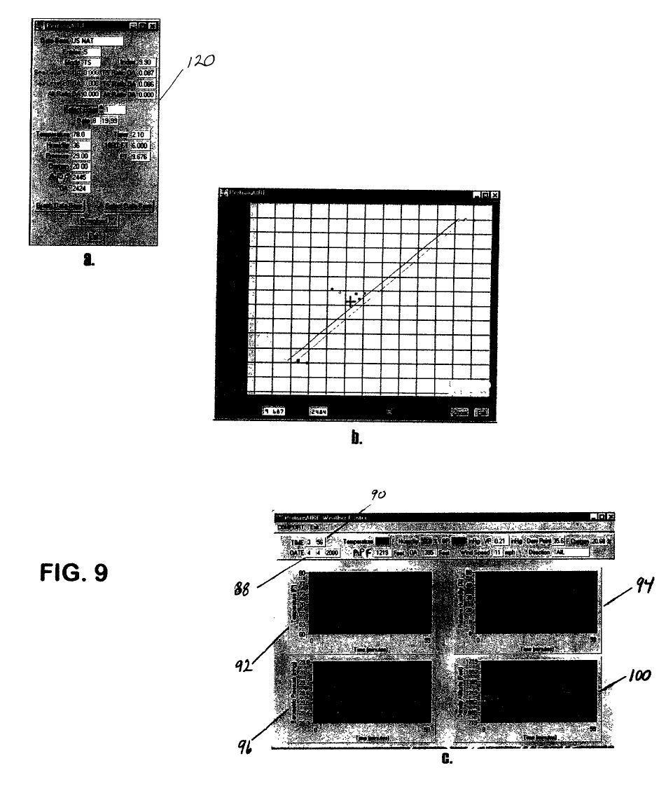

The computer may also be used to download the vehicle performance factors and run information for a particular vehicle (i.e., database). As shown on screen “b” of FIG. 9, run information characterized by calculated atmospheric performance factor and elapsed time are plotted. This plot can assist the user in identifying a bad run which does not fit the pattern of the runs for that particular vehicle. This information can also be used to assist the user in predicting how a particular vehicle will run at the plotted atmospheric performance factors. Lastly, screen “c” shows real-time air quality conditions as they are collected by remote air quality sensors 14, computed by controller 12 and then sent to the computer for plotting on the display. Shown at the top of screen “c” are the current air quality conditions at a particular time 90 and date 88. The four plots represent temperature 92, relative humidity 94, absolute pressure 96 and calculated atmospheric performance factor 100 plotted as a function of time. This information can quickly alter the user of drastic weather changes.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A method for determining operational air quality and predicting vehicle performance, the method comprising:
periodically collecting air quality conditions at a temporary reference location;
receiving the air quality conditions;
calculating an atmospheric performance factor;
recalling vehicle operational data stored in a memory location;
calculating vehicle performance factors using the atmospheric performance factor and recalled vehicle operational data; and
displaying the air quality conditions and calculated atmospheric performance factor and vehicle performance factors to a user.

2. The method of claim 1 wherein the step of periodically collecting air quality conditions at a temporary reference location includes repeatedly mounting air-collecting sensors at a mounting location on a movable unit.

3. The method of claim 2 wherein the air-collecting sensors collect one or more of the group of temperature, humidity, barometric pressure, pressure altitude, percentage of oxygen, wind speed, wind gust speed, and wind direction.

4. The method of claim 3 wherein the step of mounting the air-collecting sensors at a mounting location on a movable unit includes positioning the wind direction air-collecting sensor in a reference location.

5. The method of claim 4 wherein positioning the wind direction air-collecting sensor on the movable unit includes aligning the wind direction air-collecting sensor in the direction of vehicle travel at a particular location of use.

6. The method of Clam 4 wherein the movable unit is a transportation vehicle such as a trailer, sports utility vehicle, or truck that is repeatedly used with the claimed method.

7. The method of claim 5 wherein the direction of vehicle travel is determined by the direction of vehicle travel from a starting point to a finish point.

8. The method of claim 1 wherein the step of calculating atmospheric performance factor includes periodically determining the instant atmospheric performance factor and averaging the calculated values over a predetermined number of periodical air collections.

9. The method of claim 1 wherein the step of calculating vehicle performance factors includes recalling stored vehicle operational data in the memory location including elapsed time value, corresponding engine parameters, and the corresponding stored air quality conditions and comparing the elapsed time value, engine parameters, and calculated atmospheric performance factor to determine the vehicle performance factors for the calculated atmospheric performance factor.

10. The method of claim 1 wherein the steps of receiving the air quality conditions, calculating atmospheric performance factor, recalling vehicle operational data stored in a memory location, calculating vehicle performance factors and displaying the air quality conditions, calculated atmospheric performance factor and vehicle performance factors are controlled by a microprocessor in a single controller.

11. An apparatus for determining an atmospheric performance factor and predicting vehicle performance, the apparatus comprising:
a remote mounted air quality collection device;
a user interactive input device;
a display unit;
a transmitter;
a power source; and
a controller for receiving and storing information from the remote air quality collection device and the user interactive input device, calculating atmospheric performance factor and predicting vehicle performance factors from the collected and stored information, and displaying and storing the atmospheric performance factor and vehicle performance factors for viewing by a user.

12. The apparatus of claim 11 wherein the user interactive input device, display unit, transmitter and controller are contained in a single housing.

13. The apparatus of claim 11 wherein the remote mounted air quality collection device includes air-collecting sensors of a temperature sensor, a pressure sensor and a humidity sensor.

14. The remote mounted air quality collection device of claim 13 wherein the air-collecting sensors include at least one of the group of wind direction sensor, wind speed sensor, wind gust sensor, percentage of oxygen sensor, or light sensor.

15. The apparatus of claim 13 wherein the remote mounted air quality collection device is mounted at a temporary reference location.

16. The air-collecting sensors of claim 13 wherein the pressure sensor is a barometric pressure sensor or a pressure altimeter.

17. The remote mounted air quality collection device of claim 13 wherein the temporary reference location includes a mounting device fixed to a moveable unit.

18. The temporary reference location as defined in claim 17 wherein the moveable unit is a trailer or vehicle.

19. The remote mounted air quality collection device of claim 14 wherein the wind direction sensor is positioned in a direction of vehicle travel.

20. The remote mounted air quality collection device of claim 19 wherein the direction of vehicle travel is in a direction of travel from a starting point to an ending point.

21. The direction of vehicle travel of claim 20 wherein the starting point and ending point are defined by a the starting line and finish line racetrack.

22. The apparatus of claim 11 wherein the input device is a keypad or a mouse for allowing a user to input vehicle performance information and select operational modes, and stored and calculated data.

23. The apparatus of claim 11 wherein the display unit is a liquid crystal display or plasma display for displaying stored vehicle performance data, sensor collected data and calculated data.

24. The apparatus of claim 11 wherein the power source is a battery.

25. The apparatus of claim 11 wherein the controller includes a read and write memory storing and recalling user inputted and sensor collected information, and a microcontroller for calculating an atmospheric performance factor and vehicle performance factors.

26. The apparatus of claim 11 wherein the transmitter includes an antenna for transmitting stored and calculated atmospheric performance factor and vehicle performance factors.

27. The apparatus of claim 26 wherein the transmitter further includes a receiver for remotely displaying stored and calculated atmospheric performance factor and vehicle performance factors to a user.

28. The apparatus of claim 11 wherein the controller includes an input and output connection for sending stored and calculated atmospheric performance factor, vehicle performance factors and stored vehicle operational data to a computer, printer or other storage device.

29. The apparatus of claim 28 wherein the input and output part is an RS-232, a parallel, an USB, or an infrared sending and receiving connection.
